(19) United States
(12) Patent Application Publication
(10) Pub. No.: US 2018/0349945 A1
(43) Pub. Date: Dec. 6, 2018

(54) DYNAMIC SELECTION OF AN ADVERTISEMENT TO PRESENT TO A USER

(71) Applicant: International Business Machines Corporation, Armonk, NY (US)

(72) Inventor: PRASANNA JAYARAMAN, AUSTIN, TX (US)

(21) Appl. No.: 15/614,873

(22) Filed: Jun. 6, 2017

(51) Int. Cl. G06Q 30/02

(52) U.S. Cl. CPC G06Q 30/0242; G06Q 30/0254; G06Q 30/0277; G06Q 30/0273; G06Q 30/0243; G06Q 30/0256

(57) ABSTRACT

Dynamic selection of an advertisement to present to a user including detecting, by an advertisement selection module, a proximity between the user and a device including retrieving sensor data from at least one sensor of the device; generating, by the advertisement selection module, a current environmental profile comprising the detected proximity between the user and a device; matching, by the advertisement selection module, the current environmental profile to a first personal skip profile of a plurality of personal skip profiles for the user, wherein the first personal skip profile comprises data indicating a likelihood that the user will skip the advertisement for the detected proximity; selecting the advertisement based on the first personal skip profile including the data indicating the likelihood that the user will skip the advertisement for the detected proximity; and sending, to the device, the selected advertisement for presentation to the user.

### BACKGROUND

### Field of the Invention

The field of the invention is data processing, or, more specifically, methods, apparatus, and products for dynamic selection of an advertisement to present to a user.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

### SUMMARY

Methods, systems, and apparatus for dynamic selection of an advertisement to present to a user are disclosed in this specification. Dynamic selection of an advertisement to present to a user includes detecting, by an advertisement selection module, a proximity between the user and a device including retrieving sensor data from at least one sensor of the device; generating, by the advertisement selection module, a current environmental profile comprising the detected proximity between the user and a device; matching, by the advertisement selection module, the current environmental profile to a first personal skip profile of a plurality of personal skip profiles for the user, wherein the first personal skip profile comprises data indicating a likelihood that the user will skip the advertisement for the detected proximity; selecting, by the advertisement selection module, the advertisement based on the first personal skip profile including the data indicating the likelihood that the user will skip the advertisement for the detected proximity; and sending, to the device, the selected advertisement for presentation to the user.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system configured for dynamic selection of an advertisement to present to a user according to embodiments of the present invention.

FIG. 2 sets forth an example block diagram of a system configured for dynamic selection of an advertisement to present to a user according to embodiments of the present invention.

FIG. 3 sets forth a flow chart illustrating an exemplary method for dynamic selection of an advertisement to present to a user according to embodiments of the present invention.

FIG. 4 sets forth a flow chart illustrating an exemplary method for dynamic selection of an advertisement to present to a user according to embodiments of the present invention.

FIG. 5 sets forth a flow chart illustrating an exemplary method for dynamic selection of an advertisement to present to a user according to embodiments of the present invention.

FIG. 6 sets forth a flow chart illustrating an exemplary method for dynamic selection of an advertisement to present to a user according to embodiments of the present invention.

FIG. 7 sets forth a flow chart illustrating an exemplary method for dynamic selection of an advertisement to present to a user according to embodiments of the present invention.

### DETAILED DESCRIPTION

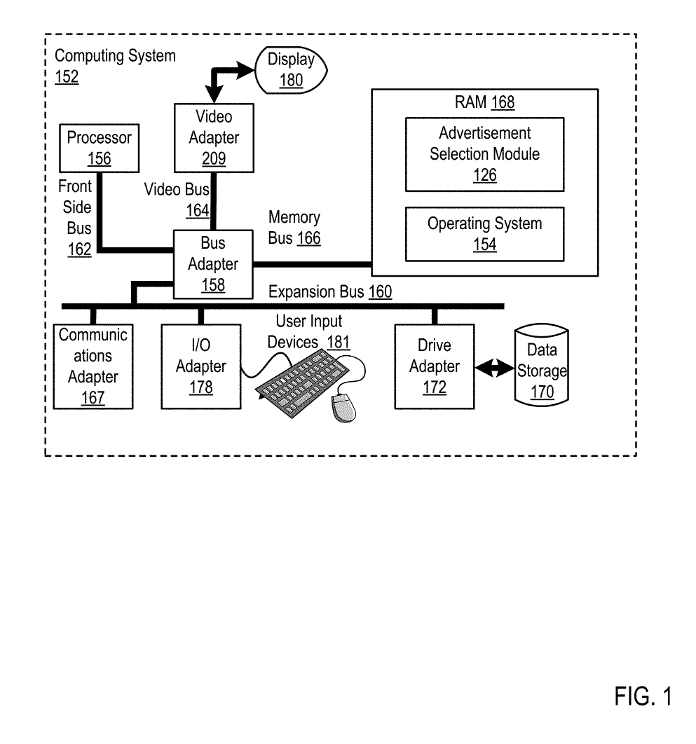

Exemplary methods, apparatus, and products for dynamic selection of an advertisement to present to a user in accordance with the present invention are described with reference to the accompanying drawings, beginning with FIG. 1. FIG. 1 sets forth a block diagram of automated computing machinery comprising an exemplary computing system (152) configured for dynamic selection of an advertisement to present to a user according to embodiments of the present invention. The computing system (152) of FIG. 1 includes at least one computer processor (156) or ‘CPU’ as well as random access memory (168) (‘RAM’) which is connected through a high speed memory bus (166) and bus adapter (158) to processor (156) and to other components of the computing system (152).

Stored in RAM (168) is an operating system (154). Operating systems useful in computers configured for dynamic selection of an advertisement to present to a user according to embodiments of the present invention include UNIX™, Linux™, Microsoft Windows™, AIX™ IBM's i OS™, and others as will occur to those of skill in the art. The operating system (154) in the example of FIG. 1 is shown in RAM (168), but many components of such software typically are stored in non-volatile memory also, such as, for example, on a disk drive (170). Also stored in RAM (168) is an advertisement selection module (126), a module of computer program instructions for dynamic selection of an advertisement to present to a user.

The computing system (152) of FIG. 1 includes disk drive adapter (172) coupled through expansion bus (160) and bus adapter (158) to processor (156) and other components of the computing system (152). Disk drive adapter (172) connects non-volatile data storage to the computing system (152) in the form of data storage (170). Disk drive adapters useful in computers configured for dynamic selection of an advertisement to present to a user according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computing system (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computing system (152) of FIG. 1 includes a communications adapter (167) for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for dynamic selection of an advertisement to present to a user according to embodiments of the present invention include modems for wired dial-up communications, Ethernet (IEEE 802.3) adapters for wired data communications, and 802.11 adapters for wireless data communications.

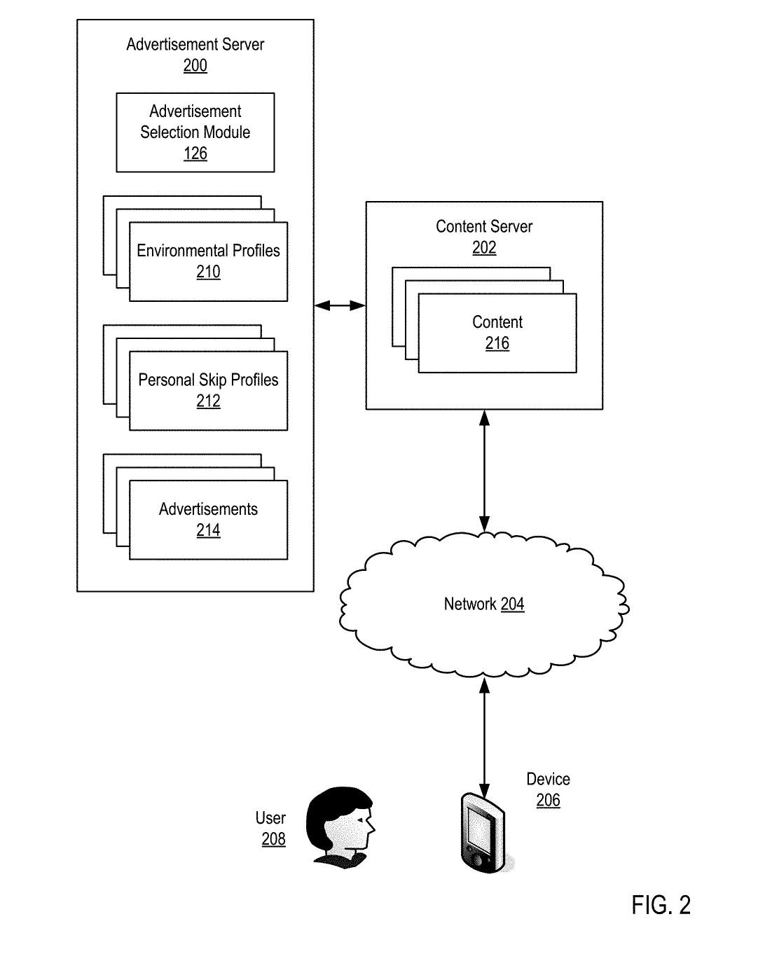

FIG. 2 shows a block diagram of an example system configured for dynamic selection of an advertisement to present to a user in accordance with embodiments of the present invention. As shown in FIG. 2, FIG. 2 includes an advertisement server (200) and content server (202) connected, via network (204), to a device (206) operated by the user (208). The advertisement server (200) includes an advertisement selection module (126), environmental profiles (210), personal skip profiles (212), and advertisements (214). The content server (202) includes content (216).

The advertisement server (200) is computer hardware, computer software, or a combination of computer hardware and software configured to host the advertisement selection module (126), environmental profiles (210), personal skip profiles (212), and advertisements (214). The advertisement server (200) may receive requests from a content server (202) for advertisements, or references to advertisements, that should be included in content (216) provided to the device (206). For example, if the user (208) of the device (206) requests media content (216) such as a music video, the content server (202) may request, from the advertisement server (200) an advertisement to play before the content (206) is played on the device (206). The content server (202) may then provide, to the device, the music video content (216) along with the advertisement provided by the advertisement server (200).

The advertisement selection module (126) may be computer hardware, software, or an aggregation of both computer hardware and computer software configured to receive data about a user (208) and device (206) and select an advertisement (214). The advertisement selection module (126) may store information about the device (206), such as data from the sensors on the device (206), in a group of environmental profiles (210). The advertisement selection module (126) may store information about user (208), such as user demographics and behavior, in a group of personal skip preferences (212).

The environmental profiles (210) are groups of data that describe a state of the device (206). The state of the device stored in the environmental profiles (210) may be described in terms of data from various sensors of the device (206). Such data may include the proximity of the user to the device, whether the device is stationary or moving, whether the device is being held, the time of day, the physical location of the device, the geographic location of the device, and any accessories (such as audio output or video output devices) currently attached to the device. The proximity of the user to the device refers to a physical distance, or range of distances, that exists between the user and the device.

The advertisement selection module (126) may generate data stored in the environmental profiles (210) based on data received from the sensors on the device (206). For example, proximity between the user and the device may be a function of different readings from different device sensors. As a specific example, if a device is stationary, but is wirelessly connected to digital jewelry through a short range wireless protocol, the advertisement selection module (126) may then determine that the user is near the device but not holding the device. This data may be included in the environmental profile. Device sensors providing data, directly or indirectly, to the advertisement selection module (126) may include, for example, gyroscopes, global positioning system hardware chips, wireless communications protocol chips, wired communications protocol chips, microphones, barometers, thermometers, battery, and cameras. Further, sensor data may include software information, such as the application currently in use.

Each environmental profile (210) may describe a different scenario for the user (208) and the device (206). For example, one environmental profile (210) may include data that describes the sensor readings for a device (206) stored in a pocket or purse of the user (208) while the user is walking. Another environmental profile (210) may include data that describes the sensor readings for a device (206) stored in a pocket or purse of the user (208) while the user is jogging. Another environmental profile (210) may include data that describes the sensor readings for a device (206) resting on a table and being used to stream video to an external video device. Another environmental profile (210) may include data that describes the sensor readings for a device (206) placed in a charging dock and being used to stream audio to wireless speakers.

The personal skip profiles (212) store data associating an environmental profile (210) to detected actions previously taken by a specific user (208) or other similar users. The environmental profiles (210) may be separate data elements or may be stored within the personal skip profiles (212). For each environmental profile (210), the personal skip profile (212) stores data indicating a likelihood that an advertisement will be skipped. The personal skip profile (212) may indicate types of advertisements that are rarely skipped by the user and types of advertisements that are frequently skipped by the user.

The personal skip profile (212) may be specific to a single user. The personal skip profile may be pre-populated (i.e., before data is gathered about a specific user) with data common to other demographically similar users. As used herein, skipping an advertisement refers to a user (208) indicating, via the device (206), that the user does not want to listen or watch the presented advertisement. For example, the user may be provided with a “skip” button while an advertisement is presented on the device (206). The user may select the “skip” button in order to stop playing the advertisement and begin or resume the presentation of the content (216).

The data indicating a likelihood that an advertisement will be skipped stored in the personal skip profile (212) may be a general indication of whether a presented advertisement will be skipped while the device is in the state described by the environmental profile (210). Alternatively, or additionally, the data indicating a likelihood that an advertisement will be skipped may include a likelihood that an advertisement will be skipped for each of a variety of types of advertisements. For example, a personal skip profile may include data that indicates that the user is only 16% likely to skip an advertisement for an environmental profile with sensor data that describes the device as resting on a table and connected to wireless speakers. As another example, a personal skip profile may include data that indicates that the user is 70% likely to skip an advertisement for new cars for an environmental profile with sensor data that describes the device as being held and connected to headphones.

The data indicating a likelihood that an advertisement will be skipped may also include an anticipated amount of time that will pass before the user skips the advertisement. The anticipated amount of time that will pass before the user skips the advertisement may be general to all presented advertisements and/or may include different anticipated amounts of time for different types of advertisements. For example, a personal skip profile for a user may indicate that the user, on average, skips advertisements after 15 seconds, but skips advertisements for haircare products, on average, after 20 seconds. As another example, a personal skip profile for a user may indicate that the user, on average, skips advertisements after 7 seconds, but skips advertisements with music, on average, after 4 seconds, and skips advertisements with a male voiceover, on average, after 6 seconds.

The personal skip profiles (212) may include other data extrapolated from the existing data. For example, using the proximity between the user and the device along with the anticipated amount of time that will pass before the user skips the advertisement may indicate how much a user likes or dislikes a particular advertisement or type of advertisement. For example, if the user is not close to the device (206), but skips a particular advertisement after a very short time passes, the advertisement selection module (126) may extrapolate the user (208) dislikes the advertisement very much.

The advertisements (214) may be data files or references to data for advertisements for presentation on the device (206). The advertisements (214) may include audio media or video media. The advertisements (214) are selected by the advertisement selection module (126) based on a detected current environmental profile (210) and a personal skip profile for the user (208).

The content server (202) is computer hardware, computer software, or a combination of computer hardware and software configured to host the content (216) requested by the user (208) via the device (206). The content (216) may be audio media, video media, or textual. The user (208) may request a particular piece of content (216). The content server (202) receives the request and locates the piece of content (216). The content server (202) may then request an advertisement (214) from the advertisement selection module (126). The advertisement selection module (126) may then select an advertisement (214) and provide the advertisement or a reference to the advertisement to the content server (202). Then content server (202) may then provide the content (216) along with the advertisement (214) for presentation on the device (206).

The device (206) is a computing device operated by the user (208) and configured to present content and advertisements to the user. The device (206) includes sensors that detect various states of the device, such as movement, proximity to the user, environmental sounds, temperature, and communications. Examples of devices (206) include, but are not limited to, desktop computers, personal communications devices such as laptop computers, smartphones, and tablets, gaming consoles, digital assistant devices, smart home appliances, and smart televisions.

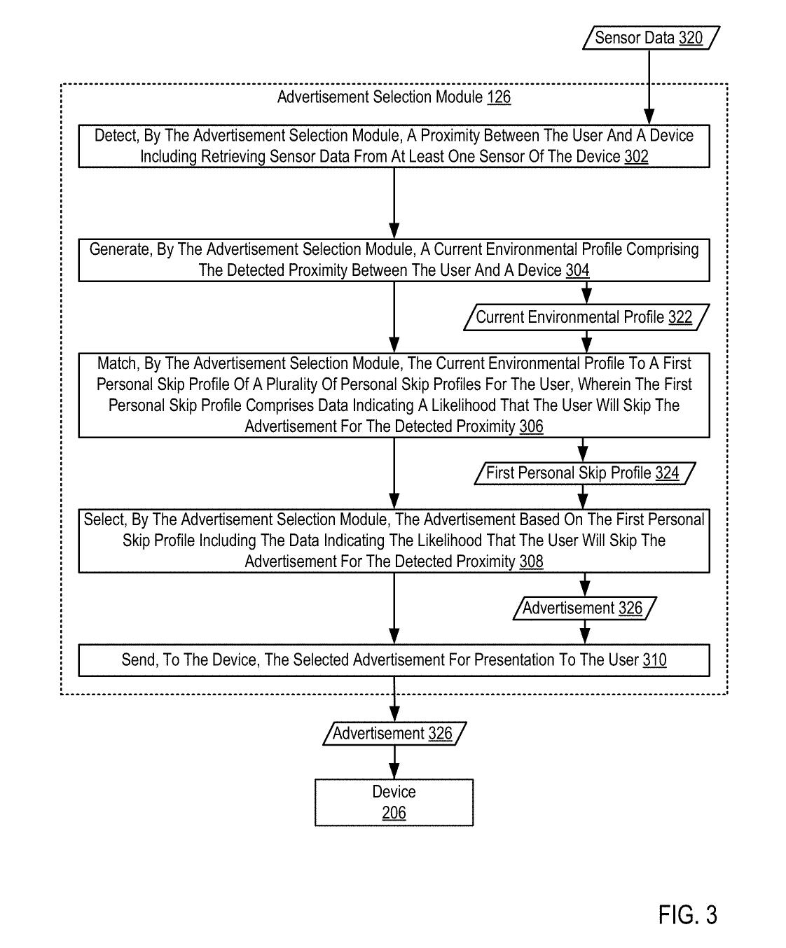

For further explanation, FIG. 3 sets forth a flow chart illustrating an exemplary method for dynamic selection of an advertisement to present to a user according to embodiments of the present invention that includes detecting (302) a proximity between the user and a device (206) including retrieving, by an advertisement selection module (126), sensor data (320) from at least one sensor of the device (206). Detecting (302), by an advertisement selection module (126), a proximity between the user and a device (206) including retrieving sensor data (320) from at least one sensor of the device (206) may be carried out by analyzing the sensor data (320) to determine the proximity between the user and the device (206). Detecting (302) a proximity between the user and a device (206) may include determining proximity using data from two or more sensors on the device (206).

For example, sensor data from the gyroscope and sensor data from the audio output chip may be retrieved. The gyroscope may indicate that the device (206) is still and face up, and the audio output chip may indicate that the device is sending audio to a wireless speaker. The sensor data may be analyzed to detect that the user is likely within 10 meters of the device (206) but is not holding the device.

Further, detecting (302) a proximity between the user and a device (206) may also include using sensor data (320) and a likelihood analysis. For example, the advertisement selection module (126) may retrieve sensor data from a limited number of sensors that provides incomplete information about the user's proximity to the device. The advertisement selection module (126) may then determine, for the available sensor data, a most likely proximity. Such a likelihood analysis may include accessing historical information about the user and the device. For example, assume that 80% of the time the device is connected to wireless speakers, the detected proximity using the audio output sensor along with other sensors is between three meters and eight meters. If the advertisement selection module (126) receives only the audio output sensor data indicating connectivity to a wireless speaker with no other sensor data, the advertisement selection module (126) may determine, using a likelihood analysis, that there is an 80% chance that the user is between three and eight meters from the device.

The method of FIG. 3 also includes generating (304), by the advertisement selection module (126), a current environmental profile (322) comprising the detected proximity between the user and a device (206). Generating (304), by the advertisement selection module (126), a current environmental profile (322) comprising the detected proximity between the user and a device (206) may be carried out by collecting the detected proximity alone or with other data to generate the current environmental profile (322).

The current environmental profile (322) may include sensor data used to detect the proximity between the user and the device. The current environmental profile (322) may also include sensor data not used to detect the proximity between the user and the device. The current environmental profile (322) may further include data not retrieved from sensors on the device, such as the type of content requested by the user. For example, the current environmental profile (322) may include the detected proximity, the current audio output for the device, and the current video output for the device.

The method of FIG. 3 also includes matching (306), by the advertisement selection module (126), the current environmental profile (322) to a first personal skip profile (324) of a plurality of personal skip profiles for the user, wherein the first personal skip profile (324) comprises data indicating a likelihood that the user will skip the advertisement for the detected proximity. Matching (306), by the advertisement selection module (126), the current environmental profile (322) to a first personal skip profile (324) of a plurality of personal skip profiles for the user, wherein the first personal skip profile (324) comprises data indicating a likelihood that the user will skip the advertisement for the detected proximity may be carried out by comparing the current environmental profile (322) to environmental profiles mapped to personal skip profiles (324) for the user.

Matching (306), by the advertisement selection module (126), the current environmental profile (322) to a first personal skip profile (324) may include an imperfect match between the current environmental profile (322) and the environmental profile associated with the first personal skip profile (324). The matched first personal skip profile (324) may be a best match or most consistent match between the current environmental profile (322) and the environmental profile associated with the first personal skip profile (324).

The method of FIG. 3 also includes selecting (308), by the advertisement selection module (126), the advertisement (326) based on the first personal skip profile (324) including the data indicating the likelihood that the user will skip the advertisement for the detected proximity. Selecting (308), by the advertisement selection module (126), the advertisement (326) based on the first personal skip profile (324) including the data indicating the likelihood that the user will skip the advertisement for the detected proximity may be carried out by determining that the advertisement is unlikely to be skipped based on the data within the first personal skip profile (324). The selected advertisement (326) may be of a type of advertisement that the first personal skip profile indicates is unlikely to be skipped by the user. The selected advertisement (326) may be of a type of advertisement that the first personal skip profile indicates that the user will allow to be presented longer before being skipped.

Selecting (308), by the advertisement selection module (126), the advertisement (326) may be in response to a request sent by the device (206) for media content for presentation on the device. Alternatively, selecting (308), by the advertisement selection module (126), the advertisement (326) may be in response to another trigger, such as a timer. For example, a smart refrigerator may periodically present skippable advertisements on a screen. At a particular time or in response to a particular scenario, the refrigerator may transmit a request for an advertisement to the advertisement selection module (126).

The method of FIG. 3 also includes sending (310), to the device (206), the selected advertisement (326) for presentation to the user. Sending (310), to the device (206), the selected advertisement (326) for presentation to the user may be carried out by transmitting, directly or via the content server, the advertisement or a reference to the advertisement to the device. Once received, the device may then present the advertisement to the user.

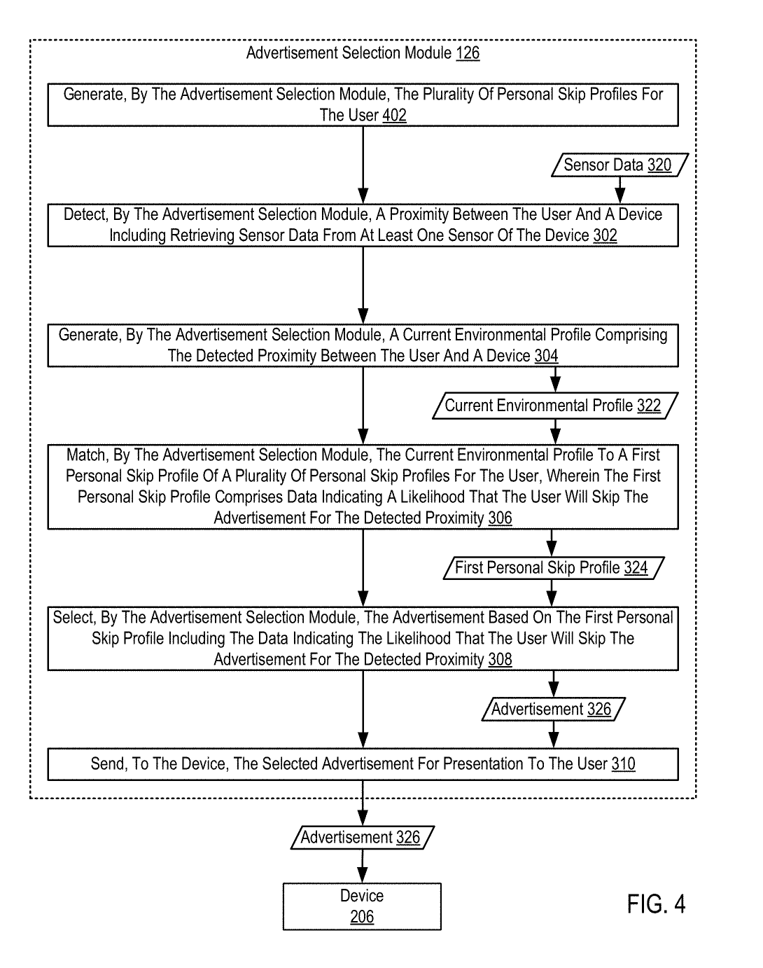

For further explanation, FIG. 4 sets forth a flow chart illustrating an exemplary method for dynamic selection of an advertisement to present to a user according to embodiments of the present invention that includes detecting (302), by an advertisement selection module (126), a proximity between the user and a device (206) including retrieving sensor data (320) from at least one sensor of the device (206); generating (304), by the advertisement selection module, a current environmental profile (322) comprising the detected proximity between the user and a device (206); matching (306), by the advertisement selection module, the current environmental profile (322) to a first personal skip profile (324) of a plurality of personal skip profiles for the user, wherein the first personal skip profile (324) comprises data indicating a likelihood that the user will skip the advertisement for the detected proximity; selecting (308), by the advertisement selection module, the advertisement (326) based on the first personal skip profile (324) including the data indicating the likelihood that the user will skip the advertisement for the detected proximity; and sending (310), to the device (206), the selected advertisement (326) for presentation to the user.

The method of FIG. 4 differs from the method of FIG. 3, however, in that FIG. 4 includes generating (402), by the advertisement selection module, the plurality of personal skip profiles for the user. Generating (402) the plurality of personal skip profiles for the user may be carried out by, for each advertisement presented to the user: identifying a type of device through which the advertisement is presented to the user; identifying a proximity between the user and the device; determining whether the user skipped the advertisement; and if the user skipped the advertisement, recording a duration of time that the advertisement was presented prior to being skipped by the user.

Identifying a type of device through which the advertisement is presented to the user may be carried out by retrieving data from the device (206), such as sensor data or device identifiers from the device. Types of devices may be general, such as laptop, tablet, or smartphone. Types of devices may be specific, such as the make and model of the device. Identifying a proximity between the user and the device may be carried out as described above with reference to step 302 of FIG. 3.

Determining whether the user skipped the advertisement may be carried out by monitoring the device (206) to determine whether the user indicated that the user does not want the presentation of the advertisement to continue. Recording a duration of time that the advertisement was presented prior to being skipped by the user may be carried out by monitoring the device (206) to determine the amount of time that lapses before the user indicates that the user does not want the presentation of the advertisement to continue.

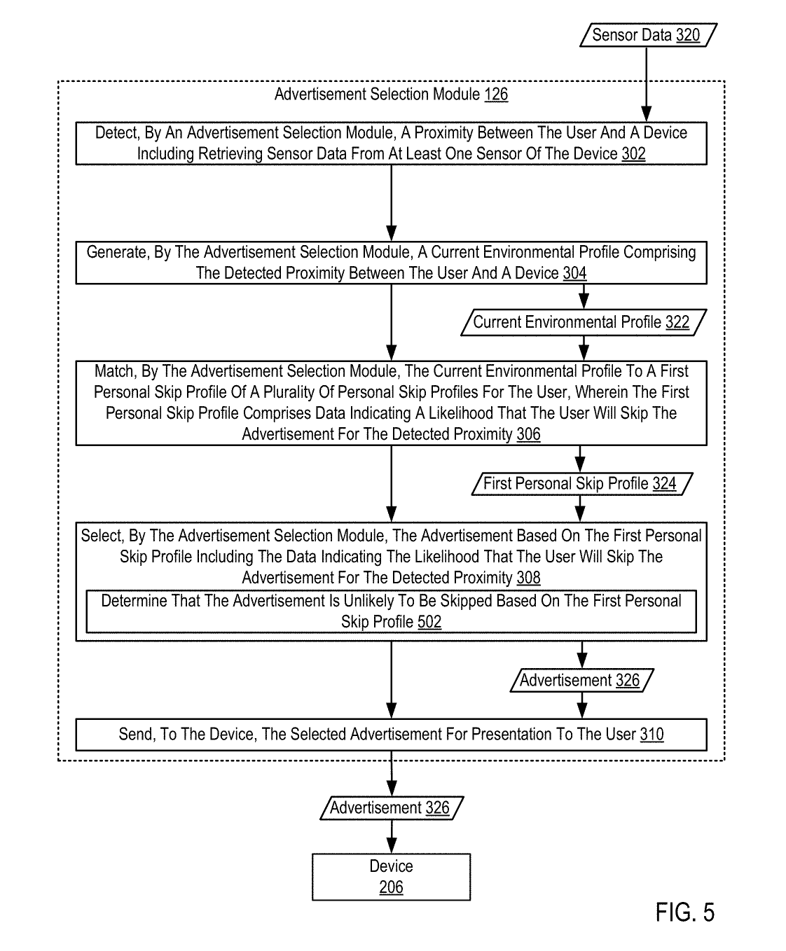

For further explanation, FIG. 5 sets forth a flow chart illustrating an exemplary method for dynamic selection of an advertisement to present to a user according to embodiments of the present invention that includes detecting (302), by an advertisement selection module, a proximity between the user and a device (206) including retrieving sensor data (320) from at least one sensor of the device (206); generating (304), by the advertisement selection module, a current environmental profile (322) comprising the detected proximity between the user and a device (206); matching (306), by the advertisement selection module, the current environmental profile (322) to a first personal skip profile (324) of a plurality of personal skip profiles for the user, wherein the first personal skip profile (324) comprises data indicating a likelihood that the user will skip the advertisement for the detected proximity; selecting (308), by the advertisement selection module, the advertisement (326) based on the first personal skip profile (324) including the data indicating the likelihood that the user will skip the advertisement for the detected proximity; and sending (310), to the device (206), the selected advertisement (326) for presentation to the user.

The method of FIG. 5 differs from the method of FIG. 3, however, in that selecting (308), by the advertisement selection module, the advertisement (326) based on the first personal skip profile (324) including the data indicating the likelihood that the user will skip the advertisement for the detected proximity includes determining (502) that the advertisement is unlikely to be skipped based on the first personal skip profile. Determining (502) that the advertisement is unlikely to be skipped based on the first personal skip profile (324) may be carried out by extracting, from the first personal skip profile, a type of advertisement that the user has a low rate of skipping. The data regarding the type of advertisement that the user has a low rate of skipping stored in the first personal skip profile (324) may be based on historical data from the user having been previously presented with a type of advertisement and monitoring the user's proximity and interaction with the device during the presentation of the advertisement.

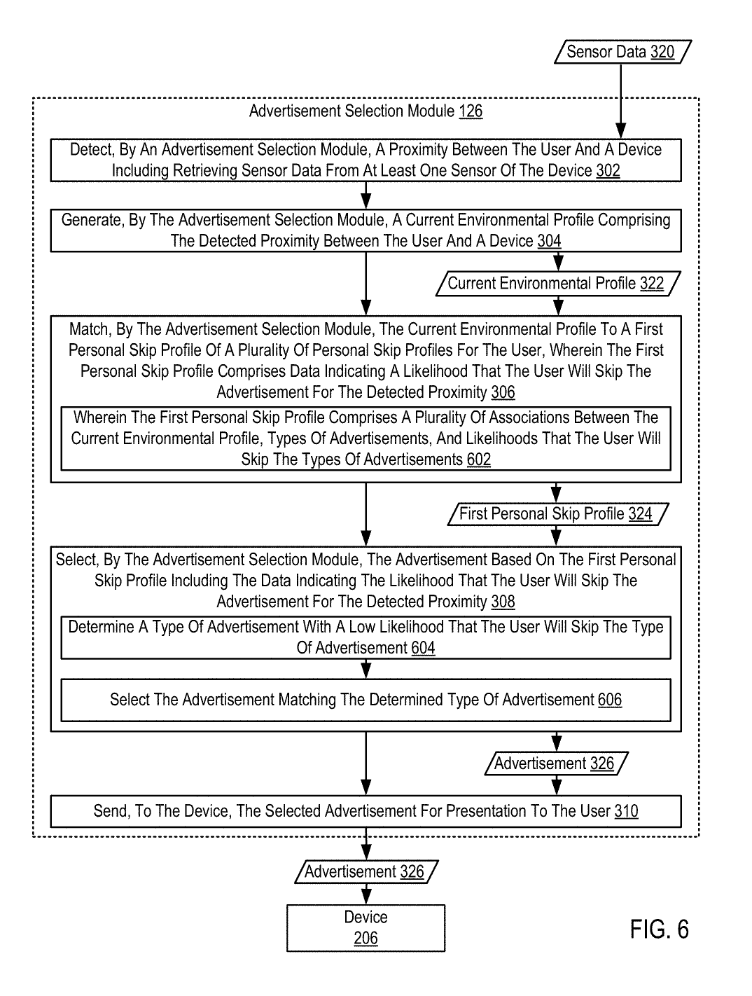

For further explanation, FIG. 6 sets forth a flow chart illustrating an exemplary method for dynamic selection of an advertisement to present to a user according to embodiments of the present invention that includes detecting (302), by an advertisement selection module, a proximity between the user and a device (206) including retrieving sensor data (320) from at least one sensor of the device (206); generating (304), by the advertisement selection module, a current environmental profile (322) comprising the detected proximity between the user and a device (206); matching (306), by the advertisement selection module, the current environmental profile (322) to a first personal skip profile (324) of a plurality of personal skip profiles for the user, wherein the first personal skip profile (324) comprises data indicating a likelihood that the user will skip the advertisement for the detected proximity; selecting (308), by the advertisement selection module, the advertisement (326) based on the first personal skip profile (324) including the data indicating the likelihood that the user will skip the advertisement for the detected proximity; and sending (310), to the device (206), the selected advertisement (326) for presentation to the user.

The method of FIG. 6 differs from the method of FIG. 3, however, in that matching (306), by the advertisement selection module, the current environmental profile (322) to a first personal skip profile (324) of a plurality of personal skip profiles for the user, wherein the first personal skip profile (324) comprises data indicating a likelihood that the user will skip the advertisement for the detected proximity includes wherein (602) the first personal skip profile (324) comprises a plurality of associations between the current environmental profile (322), types of advertisements, and likelihoods that the user will skip the types of advertisements.

The method of FIG. 6 also differs from the method of FIG. 3 in that selecting (308), by the advertisement selection module, the advertisement (326) based on the first personal skip profile (324) including the data indicating the likelihood that the user will skip the advertisement for the detected proximity includes determining (604) a type of advertisement with a low likelihood that the user will skip the type of advertisement; and selecting (606) the advertisement (326) matching the determined type of advertisement.

Determining (604) a type of advertisement with a low likelihood that the user will skip the type of advertisement may be carried out by accessing the first personal skip profile (324) and comparing the likelihoods that the user will skip each type of advertisement in the first personal skip profile (324). The advertisement selection module (126) may select a type of advertisement that the first personal skip profile (324) indicates has a low, or the lowest, likelihood of being skipped by the user. Selecting (606) the advertisement (326) matching the determined type of advertisement may be carried out by selecting an advertisement from a group of advertisements that matches, or most closely matches, the type of advertisement selected from the first personal skip profile (324).

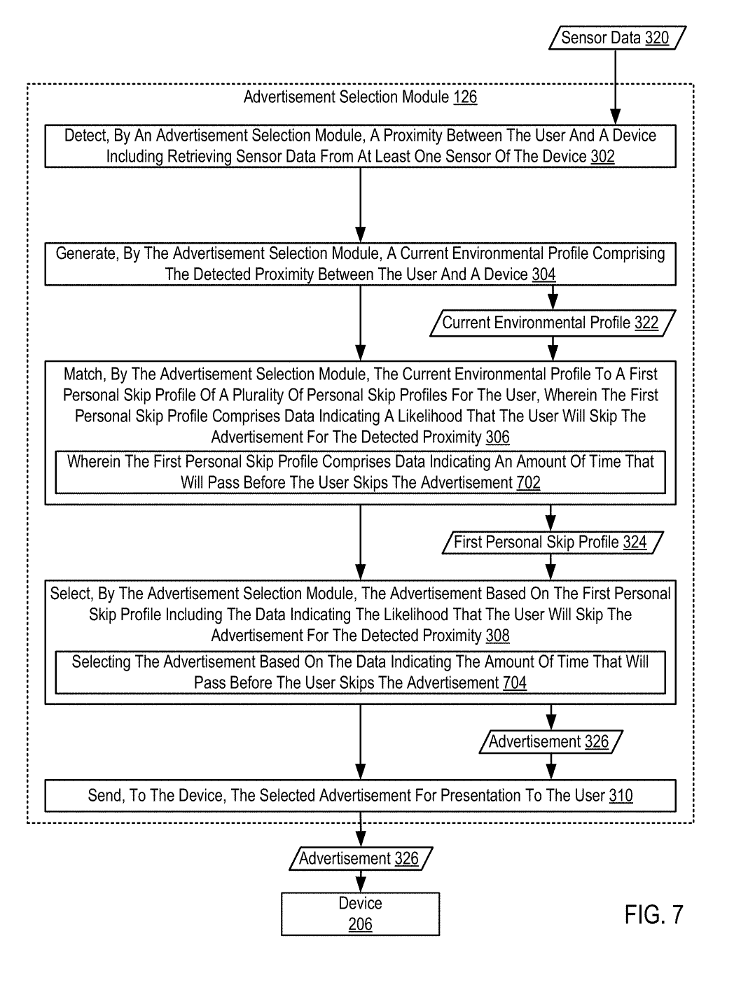

For further explanation, FIG. 7 sets forth a flow chart illustrating an exemplary method for dynamic selection of an advertisement to present to a user according to embodiments of the present invention that includes detecting (302), by an advertisement selection module, a proximity between the user and a device (206) including retrieving sensor data (320) from at least one sensor of the device (206); generating (304), by the advertisement selection module, a current environmental profile (322) comprising the detected proximity between the user and a device (206); matching (306), by the advertisement selection module, the current environmental profile (322) to a first personal skip profile (324) of a plurality of personal skip profiles for the user, wherein the first personal skip profile (324) comprises data indicating a likelihood that the user will skip the advertisement for the detected proximity; selecting (308), by the advertisement selection module, the advertisement (326) based on the first personal skip profile (324) including the data indicating the likelihood that the user will skip the advertisement for the detected proximity; and sending (310), to the device (206), the selected advertisement (326) for presentation to the user.

The method of FIG. 7 differs from the method of FIG. 3, however, in that matching (306), by the advertisement selection module, the current environmental profile (322) to a first personal skip profile (324) of a plurality of personal skip profiles for the user, wherein the first personal skip profile (324) comprises data indicating a likelihood that the user will skip the advertisement for the detected proximity includes wherein (702) the first personal skip profile (324) comprises data indicating an amount of time that will pass before the user skips the advertisement. The data indicating the amount of time that will pass before the user skips the advertisement may be based on historical user data, such the average amount of time a user allows a type of advertisement to be presented before the advertisement is skipped by the user.

The method of FIG. 7 also differs from the method of FIG. 3 in that selecting (308), by the advertisement selection module, the advertisement (326) based on the first personal skip profile (324) including the data indicating the likelihood that the user will skip the advertisement for the detected proximity includes selecting (704) the advertisement (326) based on the data indicating the amount of time that will pass before the user skips the advertisement (326). Selecting (704) the advertisement (326) based on the data indicating the amount of time that will pass before the user skips the advertisement (326) may be carried out by accessing the first personal skip profile (324) and comparing the amount of time that will pass before the user skips each type of advertisement in the first personal skip profile (324). The advertisement selection module (126) may select a type of advertisement that the first personal skip profile (324) indicates has a long, or the longest, amount of time that will pass before the user skips the type of advertisement. The advertisement selection module (126) may then select an advertisement from a group of advertisements that matches, or most closely matches, the type of advertisement selected from the first personal skip profile (324).

The above-described embodiments of the invention provide benefits that improve the operation of a computing system. Specifically, the organizational of historical user data allows an advertisement to be selected efficiently and with a minimal amount of search overhead. Further, creating associations between proximity between the user and a device and likelihood that the user will skip an advertisement reduces steps necessary for an advertisement selection module to select an advertisement, allowing the computing system hosting the advertisement selection module to operate more efficiently.

In view of the explanations set forth above, readers will recognize that the benefits of dynamic selection of an advertisement to present to a user according to embodiments of the present invention include:
Storing associations between proximity between the user and a device and likelihood that the user will skip an advertisement, increasing efficiency of advertisement selection.
Selecting advertisements that are tailored to a user including the user's proximity to the device upon which the advertisement is presented, increasing the number of relevant advertisements presented to the user.

Exemplary embodiments of the present invention are described largely in the context of a fully functional computer system for dynamic selection of an advertisement to present to a user. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of dynamic selection of an advertisement to present to a user, the method comprising:
detecting, by an advertisement selection module, a proximity between the user and a device including retrieving sensor data from at least one sensor of the device;
generating, by the advertisement selection module, a current environmental profile comprising the detected proximity between the user and a device;
matching, by the advertisement selection module, the current environmental profile to a first personal skip profile of a plurality of personal skip profiles for the user, wherein the first personal skip profile comprises data indicating a likelihood that the user will skip the advertisement for the detected proximity;
selecting, by the advertisement selection module, the advertisement based on the first personal skip profile including the data indicating the likelihood that the user will skip the advertisement for the detected proximity; and
sending, to the device, the selected advertisement for presentation to the user.

2. The method of claim 1, wherein prior to matching the current environmental profile to the first personal skip profile:
generating, by the advertisement selection module, the plurality of personal skip profiles for the user including, for each advertisement presented to the user:
identifying a type of device through which the advertisement is presented to the user;
identifying a proximity between the user and the device;
determining whether the user skipped the advertisement; and
if the user skipped the advertisement, recording a duration of time that the advertisement was presented prior to being skipped by the user.

3. The method of claim 1, wherein selecting the advisement comprises determining that the advertisement is unlikely to be skipped based on the first personal skip profile.

4. The method of claim 1, wherein the first personal skip profile comprises a plurality of associations between the current environmental profile, types of advertisements, and likelihoods that the user will skip the types of advertisements, and
wherein selecting the advertisement based on the first personal skip profile comprises:
determining a type of advertisement with a low likelihood that the user will skip the type of advertisement; and
selecting the advertisement matching the determined type of advertisement.

5. The method of claim 1, wherein the first personal skip profile comprises data indicating an amount of time that will pass before the user skips the advertisement, and wherein selecting the advertisement based on the first personal skip profile comprises selecting the advertisement based on the data indicating the amount of time that will pass before the user skips the advertisement.

6. The method of claim 1, wherein generating the current environmental profile comprises one selected from a group comprising detecting a current audio output for the device and detecting a current video output for the device.

7. The method of claim 1, wherein the advertisement is selected and sent in response to a user initiating the presentation of media content on the device.

8. An apparatus for dynamic selection of an advertisement to present to a user, the apparatus comprising a computer processor, a computer memory operatively coupled to the computer processor, the computer memory having disposed within it computer program instructions that, when executed by the computer processor, cause the apparatus to carry out the steps of:
detecting, by an advertisement selection module, a proximity between the user and a device including retrieving sensor data from at least one sensor of the device;
generating, by the advertisement selection module, a current environmental profile comprising the detected proximity between the user and a device;
matching, by the advertisement selection module, the current environmental profile to a first personal skip profile of a plurality of personal skip profiles for the user, wherein the first personal skip profile comprises data indicating a likelihood that the user will skip the advertisement for the detected proximity;
selecting, by the advertisement selection module, the advertisement based on the first personal skip profile including the data indicating the likelihood that the user will skip the advertisement for the detected proximity; and
sending, to the device, the selected advertisement for presentation to the user.

9. The apparatus of claim 8, wherein prior to matching the current environmental profile to the first personal skip profile:
generating, by the advertisement selection module, the plurality of personal skip profiles for the user including, for each advertisement presented to the user:
identifying a type of device through which the advertisement is presented to the user;
identifying a proximity between the user and the device;
determining whether the user skipped the advertisement; and
if the user skipped the advertisement, recording a duration of time that the advertisement was presented prior to being skipped by the user.

10. The apparatus of claim 8, wherein selecting the advisement comprises determining that the advertisement is unlikely to be skipped based on the first personal skip profile.

11. The apparatus of claim 8, wherein the first personal skip profile comprises a plurality of associations between the current environmental profile, types of advertisements, and likelihoods that the user will skip the types of advertisements, and
wherein selecting the advertisement based on the first personal skip profile comprises:
determining a type of advertisement with a low likelihood that the user will skip the type of advertisement; and
selecting the advertisement matching the determined type of advertisement.

12. The apparatus of claim 8, wherein the first personal skip profile comprises data indicating an amount of time that will pass before the user skips the advertisement, and wherein selecting the advertisement based on the first personal skip profile comprises selecting the advertisement based on the data indicating the amount of time that will pass before the user skips the advertisement.

13. The apparatus of claim 8, wherein generating the current environmental profile comprises one selected from a group comprising detecting a current audio output for the device and detecting a current video output for the device.

14. The apparatus of claim 8, wherein the advertisement is selected and sent in response to a user initiating the presentation of media content on the device.

15. A computer program product for dynamic selection of an advertisement to present to a user, the computer program product disposed upon a computer readable medium, the computer program product comprising computer program instructions that, when executed, cause a computer to carry out the steps of:
detecting, by an advertisement selection module, a proximity between the user and a device including retrieving sensor data from at least one sensor of the device;
generating, by the advertisement selection module, a current environmental profile comprising the detected proximity between the user and a device;
matching, by the advertisement selection module, the current environmental profile to a first personal skip profile of a plurality of personal skip profiles for the user, wherein the first personal skip profile comprises data indicating a likelihood that the user will skip the advertisement for the detected proximity;
selecting, by the advertisement selection module, the advertisement based on the first personal skip profile including the data indicating the likelihood that the user will skip the advertisement for the detected proximity; and
sending, to the device, the selected advertisement for presentation to the user.

16. The computer program product of claim 15, wherein prior to matching the current environmental profile to the first personal skip profile:
generating, by the advertisement selection module, the plurality of personal skip profiles for the user including, for each advertisement presented to the user:
identifying a type of device through which the advertisement is presented to the user;
identifying a proximity between the user and the device;
determining whether the user skipped the advertisement; and
if the user skipped the advertisement, recording a duration of time that the advertisement was presented prior to being skipped by the user.

17. The computer program product of claim 15, wherein selecting the advisement comprises determining that the advertisement is unlikely to be skipped based on the first personal skip profile.

18. The computer program product of claim 15, wherein the first personal skip profile comprises a plurality of associations between the current environmental profile, types of advertisements, and likelihoods that the user will skip the types of advertisements, and
wherein selecting the advertisement based on the first personal skip profile comprises:
determining a type of advertisement with a low likelihood that the user will skip the type of advertisement; and
selecting the advertisement matching the determined type of advertisement.

19. The computer program product of claim 15, wherein the first personal skip profile comprises data indicating an amount of time that will pass before the user skips the advertisement, and wherein selecting the advertisement based on the first personal skip profile comprises selecting the advertisement based on the data indicating the amount of time that will pass before the user skips the advertisement.

20. The computer program product of claim 15, wherein generating the current environmental profile comprises one selected from a group comprising detecting a current audio output for the device and detecting a current video output for the device.
